(19) United States
(12) Patent Application Publication
(10) Pub. No.: US 2026/0195214 A1
(43) Pub. Date: Jul. 9, 2026

(54) OFF-DIE ERROR CORRECTION FOR MEMORY DEVICES

(71) Applicant: Micron Technology, Inc., Boise, ID (US)

(72) Inventor: Marco Sforzin, Cernusco Sul Naviglio MI (IT)

(21) Appl. No.: 19/407,781

(22) Filed: Dec. 3, 2025

Related U.S. Application Data
(60) Provisional application No. 63/743,079, filed on Jan. 8, 2025.

(51) Int. Cl. G06F 11/10

(52) U.S. Cl. CPC G06F 11/1004

(57) ABSTRACT

A variety of applications can include a memory system having off-die error correction for memory devices. The off-die error correction can include operation of single error correction logic circuits followed by an error correction decoder that operates on results of operation of the single error correction circuits. The memory system can include a media subsystem, having multiple memory dies for data storage and dies for parity, and a controller external to the media subsystem and coupled to the media subsystem. The controller can have multiple single error correction logic circuits to operate on a data frame received from a set of memory dies of the multiple memory dies. Each single error correction logic circuit can be assigned to operate on data of the data frame retrieved from a subset of the set of memory dies. Additional apparatus, systems, and methods disclosed.

### PRIORITY APPLICATION

This application claims the benefit of priority to U.S. Provisional Application Ser. No. 63/743,079, filed Jan. 8, 2025, which is incorporated herein by reference in its entirety.

### FIELD OF THE DISCLOSURE

Embodiments of the disclosure relate generally to electronic devices and, more specifically, to storage memory devices and operation thereof.

### BACKGROUND

Memory devices are typically provided as internal, semiconductor, integrated circuits in computers or other electronic devices in a variety of manufactured products. There are many different types of memory, including volatile and non-volatile memory. Volatile memory requires power to maintain its data, and examples of volatile memory include random-access memory (RAM), dynamic random-access memory (DRAM), static RAM (SRAM), and synchronous dynamic random-access memory (SDRAM), among others. Non-volatile memory can retain stored data when not powered, and examples of non-volatile memory include flash memory, read-only memory (ROM), electrically erasable programmable ROM (EEPROM), erasable programmable ROM (EPROM), resistance variable memory, such as phase-change random-access memory (PCRAM), resistive random-access memory (RRAM), magnetoresistive random-access memory (MRAM), and three-dimensional (3D) XPoint™ memory, among others.

### BRIEF DESCRIPTION OF THE DRAWINGS

The drawings, which are not necessarily drawn to scale, illustrate generally, by way of example, but not by way of limitation, various embodiments discussed in the present document.

FIG. 1 is a representation of example memory dies of a memory system in which data of a data frame are distributed along with parity bits, according to various embodiments.

FIG. 2 is a representation of the example set of memory dies of FIG. 1 in which the data of the data frame partitioned in the set of memory dies is grouped into subsets of the set of memory dies, according to various embodiments.

FIG. 3 is a representation of an example group of memory dies of FIG. 2, according to various embodiments.

FIG. 4 is a representation indicating that the partition of data of a data frame illustrated in the representation of FIG. 2 can be formed into codewords by bounded single error correction, according to various embodiments.

FIG. 5 is a compressed representation for an example syndrome pattern assignment for bounded error correction, according to various embodiments.

FIGS. 6A-6C illustrate a representation of an example transposed parity check matrix for bounded error correction of the data of the data frame from the first and second memory dies of FIGS. 1 and 2, providing one of five codewords, according to various embodiments.

FIG. 7 shows differences between the probability of not being able to correct an error of a codeword for a standard Hamming decoder and for a bounded single error correction Hamming decoder, according to various embodiments.

FIG. 8 illustrates shows possible reductions of the discrepancy between curves of FIG. 7, according to various embodiments.

FIG. 9 is a representation of at least portions of an example memory system having a media subsystem with at least one rank of memory dies, where bounded single error correction operations can be implemented for the data of the media subsystem, according to various embodiments.

FIG. 10 is a representation of an example memory system having a media subsystem coupled to a controller by multiple buses, where bounded single error correction operations can be implemented for the data of media subsystem, according to various embodiments.

FIG. 11 is a flow diagram of features of an example method of operating a memory system, according to various embodiments.

FIG. 12 illustrates a block diagram of an example machine that can include one or more memory systems coupled to a controller by buses, where bounded single error correction operations can be implemented in the controller for the data of the one or more memory systems, according to various embodiments.

### DETAILED DESCRIPTION

The following detailed description refers to the accompanying drawings that show, by way of illustration and not limitation, various embodiments in which an invention can be practiced. These embodiments are described in sufficient detail to enable those skilled in the art to practice these and other embodiments. Other embodiments may be utilized, and structural, logical, mechanical, and electrical changes may be made to these embodiments. The various embodiments are not necessarily mutually exclusive, as some embodiments can be combined with one or more other embodiments to form new embodiments. The following detailed description is, therefore, not to be taken in a limiting sense.

A number of mechanisms can be implemented to correct for errors in data stored in memory systems. One approach includes storing data as bits across a number of memory dies and storing parity bits associated with the data bits in another number of memory dies. The parity bits of such memory dies can be used by a decoder external to the data and parity memory dies to correct bit errors when retrieving data from these memory dies. In addition, single error correction (SEC) can be implemented within the data memory dies prior to reading out the data. SEC can be accomplished using logic circuitry operating on data bits and parity bits for the data bits stored within each data memory die. However, SEC logic circuitry uses area in memory dies that could be utilized for increased data storage. Efficient application or design of SEC can provide enhanced use of memory die area that can lead to increased data capacity.

In various embodiments, a memory system can be structured including a media subsystem having multiple memory dies for data storage and dies for parity and a controller external to the media subsystem and coupled to the media subsystem, with the controller having multiple SEC logic circuits to provide SEC for the data retrieved from the multiple memory dies. The arrangement of SEC logic circuits in the controller external to the memory dies opens up area in the memory dies for other functions such as, but not limited to, additional data memory storage. The multiple SEC logic circuits can operate on a data frame received from a set of memory dies of the multiple memory dies, where each single error correction logic circuit is assigned to operate on data of the data frame retrieved from a subset of the set of memory dies. The subset of memory dies can include at least two memory dies. The controller can also include a decoder to operate on results of operation of the single error correction circuits. Media, herein, refers to a plurality of memory structures such as memory dies.

In such a memory system, each SEC logic circuit can be structured to generate a codeword of the data from a respective subset bounded such that multiple errors of a first region of the respective subset does not affect a second region of the respective subset. The first region can be one memory die of the subset of memory dies and the second region can be a different memory die of the subset of memory dies. Additionally, the first region can be a region within one memory die of the subset and the second region can be another region within the one memory die. The SEC logic circuit provides parity bits for the codeword of the data from the respective subset bounded. Each single error correction logic circuit can be structured to use a parity check matrix for a syndrome pattern assignment corresponding to the respective subset. The parity check matrix transpose can include rows associated with each memory die of the subset of memory dies, rows associated with data buses from which data is retrieved with respect to each memory die of the subset of memory dies, and rows associated with an amount of data corresponding to each data bus of each memory die of the subset of memory dies.

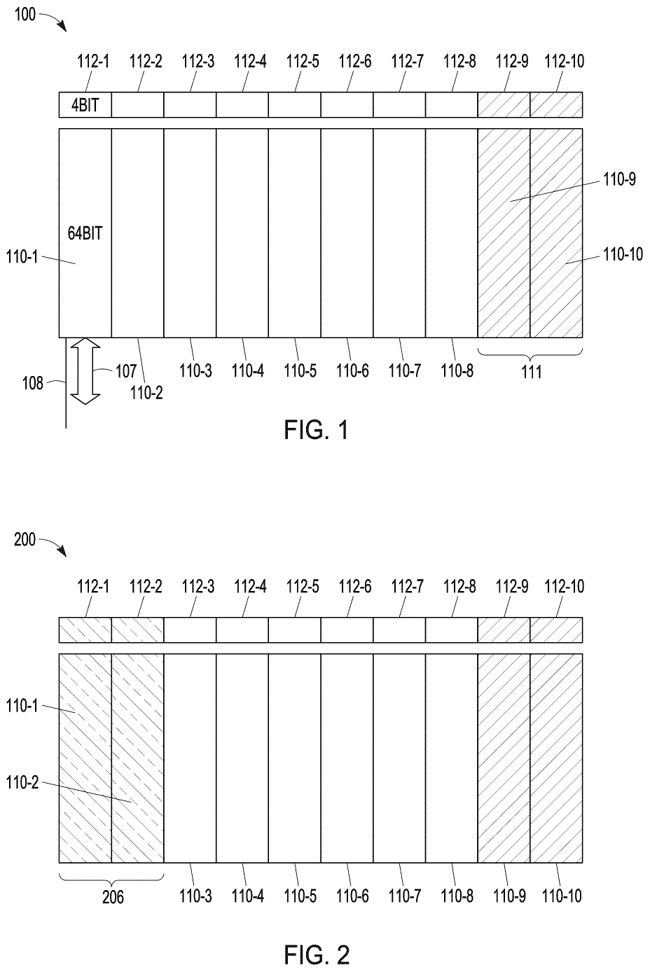

FIG. 1 is a representation 100 of memory dies of a memory system in which data of a data frame are distributed along with parity bits. Representation 100 illustrates ten memory dies 110-1, 110-2 . . . 110-9, and 110-10 in which data of a data frame is read or written. Each memory die of ten memory dies 110-1, 110-2 . . . 110-9, and 110-10 can be individually coupled to a data query (DQ) bus. For example, DQ bus 107 can have four DQ lines to transfer four bits, with a burst length (BL) of sixteen bits, storing sixty-four bits of the data frame in memory die 110-1. Memory dies 110-2 . . . 110-7 and 110-8 can store sixty-four bits of the data frame in the same manner as memory die 110-1. Memory dies 110-9 and 110-10 can be arranged to store parity bits for a Reed-Solomon (RS) decoder coupled externally to memory dies 110-2 . . . 110-9, and 110-10. A Reed-Solomon code operates on a block of data called symbols and is able to detect and correct multiple symbol errors.

A direct linked error protocol (DLEP) can be implemented to store parity bits for the data of the data frame of the individual memory dies 110-1, 110-2 . . . 110-9, and 110-10 within these memory dies. With DLEP enabled, the parity bits in a memory die can be accessed for an external host or external controller for the memory device. DLEP can be enabled/disabled after a memory device, such as a DRAM, is fully initialized and the entire memory device is in an idle state. DLEP can be enabled at time zero and can remain enabled for the life of the device. The enable/disable configuration data can be stored in a mode register in the memory die. Parity bits for the data bits of the data frame in a memory die 110-K can be stored in DLEP memory area 112-K of memory die 110-k, for K=1, 2, . . . 7, 8. Parity bits for the parity data of the data frame in a memory die 110-L can be stored in DLEP memory area 112-L of memory die 110-L, for L=9, 10. Four parity bits can be stored in a DLEP area for each sixty-four data bits. The parity bits from the DLEP memory area 112-1 can be transferred in and out of memory die 110-1 using a data mask inversion (DMI) pin of memory die 110-1 coupled to a DMI line 108 to an outside device. One DMI pin/line may be implemented for every four DQ lines. Alternatively, DLEP bits could be transmitted on DQs pin with an extra-burst beat, for example, a BL of 17 from a BL of 16. DMI is a dual use bi-directional signal used to indicate data to be masked, and data which is inverted on an internal bus. A DMI pin can be used for other functions in a memory die, where use for indicating data masking and inversion can be controlled by configuration data in a mode register. Memory dies 110-2 . . . 110-9, and 110-10 can be structured in the same manner as memory die 110-1 with respect to a DLEP memory area, a DMI pin and a DMI line. The full data frame of representation 100 has a size of 680 bits provided as (64 bits+4 bits) per memory die multiplied by 10 memory dies.

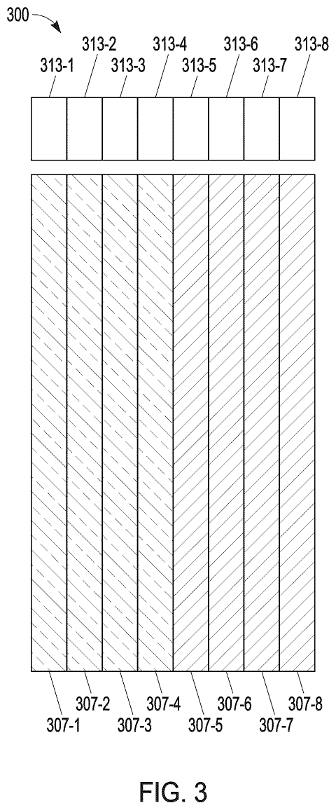

FIG. 2 is a representation 200 of the set of memory dies of FIG. 1 in which the data of the data frame partitioned in the set of memory dies is grouped into subsets of the set of memory dies. In the arrangement of FIG. 2, the memory dies are grouped in subsets of two memory dies. Memory dies 110-1 and 110-2 are treated as a group 206 to be processed for SEC in a structure outside of memory dies 110-1 and 110-2, eliminating fabrication and use of SEC logic circuitry inside memory dies 110-1 and 110-2. Memory dies 110-3 and 110-4, memory dies 110-5 and 110-6, memory dies 110-7 and 110-8, and memory dies 110-9, and 110-10 can be formed as groups of two memory dies whose data of a data frame is subjected to SEC in logic circuitry external to these memory dies. Group 206 has 128 data bits and 8 parity bits. Using DLEP, on-die-SEC can be replaced with an on-ASIC-SEC working on two data prefetch operations of two different die and with bounded die capability. The ASIC (application-specific integrated circuit) can be a controller for memory dies 110-1, 110-2 . . . 110-9, and 110-10.

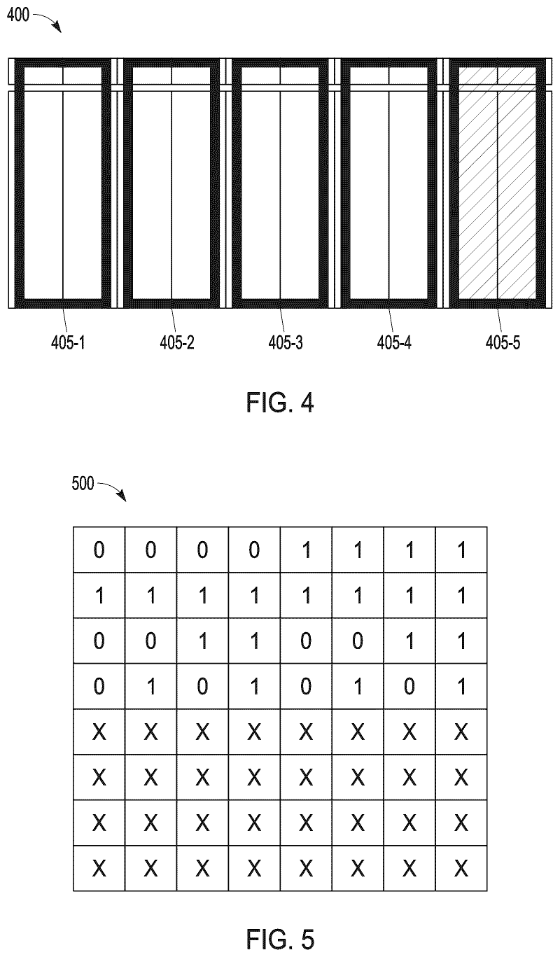

FIG. 3 is a representation 300 of group 206 of memory dies of FIG. 2. Memory die 110-1 and DLEP memory area 112-1 are shown having memory regions 307-1, 307-2, 307-3, and 307-4 associated with four DQ lines to memory die 110-1. DLEP memory area 112-1 is shown having memory locations 313-1, 313-2, 313-3, and 313-4 for the data bits associated with the four DQ lines to memory die 110-1. Memory die 110-2 and DLEP memory area 112-2 are shown having memory regions 307-5, 307-6, 307-7, and 307-8 associated with four DQ lines to memory die 110-2. DLEP memory area 112-2 is shown having memory locations 313-5, 313-6, 313-7, and 313-8 for the data bits associated with the four DQ lines to memory die 110-2.

SEC of the data bits and parity bits of group 206 can be conducted exterior to memory dies 110-1 and 110-2 in a bounded technique. In the bounded technique, multiple errors in a region of memory die 110-1 does not affect single error status of the data bits in memory die 110-2. In addition, in the bounded technique, multiple errors in a single region of memory die 110-1 does affect single error status of the data bits in another single region of memory die 110-1. SEC technique to keep multiple errors in a memory die without affecting another memory die can be referred to as bounded SEC (BSEC). BSEC can be conducted outside memory dies 110-1, 110-2 . . . 110-9, and 110-10 using BSEC logic circuitry in an ASIC, which can be a controller coupled to a media subsystem having memory dies 110-1, 110-2 . . . 110-9, and 110-10.

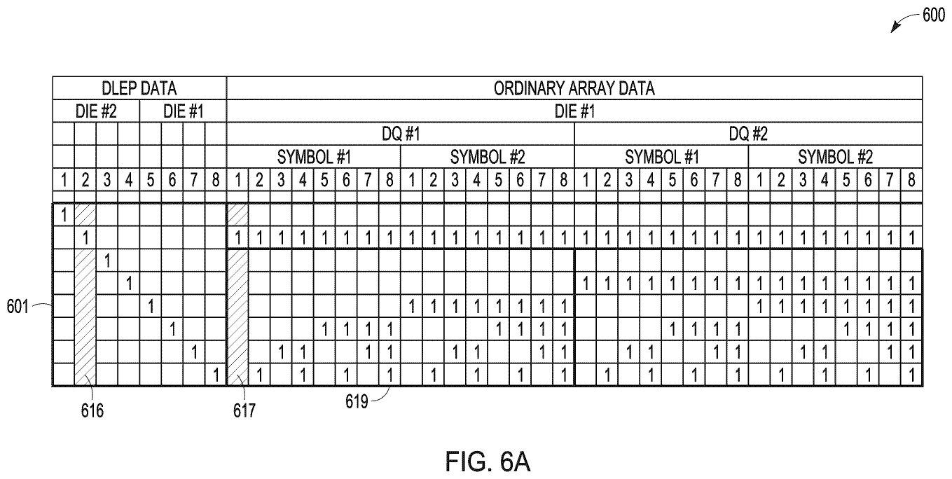

FIG. 4 is a representation 400 indicating that the partition of data of a data frame illustrated in representation 200 of FIG. 2 can be formed into codewords by BSEC. The data of the data frame in the ten memory dies 110-1, 110-2 . . . 110-9, and 110-10 of FIG. 2 can operated on as groups of two memory dies using BSEC logic circuitry in an ASIC external to the memory dies, forming five codewords associated with memory die groups 405-1, 405-2, 405-3, 405-4, and 405-5. Each BSEC codeword consists of the one hundred thirty-six bits provided by two memory die components in a single access. One hundred twenty-eight bits come from DQ lines as data bits and eight bits come from a DMI line as DLEP bits or alternatively from an extra burst beat. The five codewords associated with memory die groups 405-1, 405-2, 405-3, 405-4, and 405-5 are from BSEC decoders once the bits have arrived at the ASIC controller. The bounded nature of the five codewords is derived from using a parity check matrix constructed to provide the bounded condition.

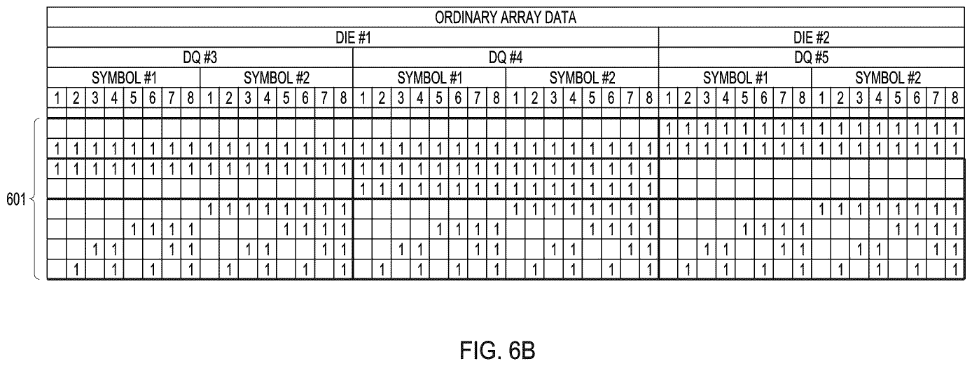

FIG. 5 is a compressed representation 500 for syndrome pattern assignment for bounded error correction. A syndrome, S, is defined by a received codeword x and a parity check matrix, H, by the relationship S=xH^{T}, where T means transpose. The vector (x) matrix (H^{T}) multiplication can be performed in the binary field, consistent of the elements 0 and 1, where the addition is an XOR operation and the multiplication is an AND operation. Errors in the received codeword are identified by the syndrome, where the value of the syndrome is the position of the code at which the error is located. With a binary code, an error of 0 can be switched to a 1. The syndrome can also be computed starting from the error vector e as: S=eH^{T}. If the vector e contains just one 1, with all of the remaining positions being 0s, then S is exactly the column of H^{T} corresponding to the position in e containing the 1.

Compressed representation 500 has eight columns, where the first four columns correspond to DQ lines to memory die 110-1 and the second four columns correspond to DQ lines to memory die 110-2. The first two rows correspond to memory die 110-1 and memory die 110-2, which effectively identify memory die 110-1 and memory die 110-1. The combination of the first row of the first four columns having the value 0 and the second row of the first four columns having the value 1 identifies first memory die 110-1. The combination of the first row of the second four columns having the value 1 and the second row of the second four columns having the value 1 identifies second memory die 110-2.

The combination of the third row of the first column of the first four columns having the value 0 and the fourth row of the first column of the first four columns having the value 0 corresponds to the first DQ line to the first memory die 110-1, identifying the first DQ line to the first memory die 110-1. The combination of the third row of the second column of the first four columns having the value 0 and the fourth row of the second column of the first four columns having the value 1 corresponds to the second DQ line to the first memory die 110-1, identifying the second DQ line to the first memory die 110-1. The combination of the third row of the third column of the first four columns having the value 1 and the fourth row of the third column of the first four columns having the value 0 corresponds to the third DQ line to the first memory die 110-1, identifying the third DQ line to the first memory die 110-1. The combination of the third row of the fourth column of the first four columns having the value 1 and the fourth row of the fourth column of the first four columns having the value 1 corresponds to the fourth DQ line to the first memory die 110-1, identifying the fourth DQ line to the first memory die 110-1.

The combination of the third row of the first column of the second four columns having the value 0 and the fourth row of the first column of the second four columns having the value 0 corresponds to the first DQ line to the second memory die 110-2, identifying the first DQ line to the second memory die 110-2. The combination of the third row of the second column of the second four columns having the value 0 and the fourth row of the second column of the second four columns having the value 1 corresponds to the second DQ line to the second memory die 110-2, identifying the second DQ line to the second memory die 110-2. The combination of the third row of the third column of the second four columns having the value 1 and the fourth row of the third column of the second four columns having the value 0 corresponds to the third DQ line to the second memory die 110-2, identifying the third DQ line to the second memory die 110-2. The combination of the third row of the fourth column of the second four columns having the value 1 and the fourth row of the fourth column of the second four columns having the value 1 corresponds to the fourth DQ line to the second memory die 110-2, identifying the fourth DQ line to the second memory die 110-2. The matrix bits identifying the DQ lines to the second memory die 110-2 is the same as the matrix bits identifying the DQ lines to the first memory die 110-1, except that the DQ matrix bits are under (directly below first and second rows) the matrix bits identifying the respective memory dies.

Since each memory device of memory dies 110-1, 110-2 . . . 110-9, and 110-10 contains sixty-four bits of data of the data frame received as a BL of sixteen bits from each DQ line of four DQ lines, representation 500 of a transposed parity check matrix has sixteen entries for each identified DQ line of each identified memory die. The sixteen entries for each identified DQ line are provided as four rows of sixteen (42) columns, where one entry in rows five through eight of representation 500 is shown as X constituting sixteen columns. For example, for the first column having 0100 as the entries in the first four rows, X represents each of 0001, 0010, 0011, 0100, 0101, 0110, 0111, 1000, 1001, 1010, 1011, 1100, 1101, 1110, 1111 signifying sixteen columns with these entries for rows five through eight following 0100 as the entries in the first four rows. The values of X are the same in each entry of representation 500, where the columns differ by the entries in the first four rows of the columns. The compressed representation 500 is generated for the bounded condition of representation 300 of FIG. 3, which can be expanded for the other four groupings two memory dies.

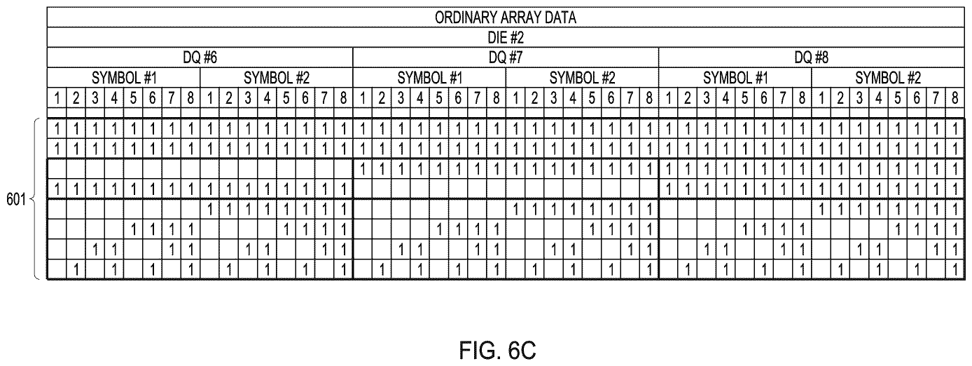

FIGS. 6A-6C illustrate a representation 600 of a parity check matrix transpose (H^{T}) 601 for BSEC of the data of the data frame from the first and second memory dies of FIGS. 1 and 2, providing one of five codewords. H^{T 601} can be generated using the procedure associated with FIG. 4 extending the representation of X into the number of appropriate columns. H^{T} 601 represents the parity check matrix of a single BSEC. For ease of presentation, the entries are shown as a 1 or an empty entry (blank), where the empty entry is a 0. H^{T} 601 for the first BSEC is associated with the one hundred twenty-eight data bits and eight parity bits of group 206, providing a first codeword of 136 bits. H^{T} 601 can be viewed as having two sections, where DLEP data is associated with the first section of the two sections and ordinary data of the data frame is associated with the second section of the two sections. H^{T} 601 has eight rows and one hundred and thirty-six columns. The first section, associated with the DLEP data, has eight rows and eight columns, and has the values of an identity matrix. The second section, associated with ordinary data, has eight rows and one hundred twenty-eight columns, and is divided into two subsections, with the first subsection associated with the first die (memory die 110-1) and the section subsection associated with the second die (memory die 110-2). The first two rows of the first subsection has the values 0 and 1, respectively, for each of forty-eight columns identifying die #1. The first two rows of the second subsection has the values 1 and 1, respectively, for each of forty-eight columns identifying memory die #2. The third row and the forth row has the values 0 and 0, respectively, for a first set of sixteen columns, the values 0 and 1, respectively, for a second set of sixteen columns, the values 1 and 0, respectively, for a third set of sixteen columns, and the values 1 and 1, respectively, for a fourth set of sixteen columns, identifying DQ #1, DQ #2, DQ #3, and DQ #4, respectively, for die #1. The third row and the forth row has the values 0 and 0, respectively, for a fifth set of sixteen columns, the values 0 and 1, respectively, for a sixth set of sixteen columns, the values 1 and 0, respectively, for a seventh set of sixteen columns, and the values 1 and 1, respectively, for an eighth set of sixteen columns, identifying DQ #5, DQ #6, DQ #7, and DQ #8, respectively, for die #2.

Each of DQ #K, K=1, 2 . . . 7, and 8, can be represented in H^{T} 601 as two symbols, where a symbol is a vector of eight bits. Each column of H^{T} 601 is an eight-bit vector associated with a bit position of a symbol, containing the signature of that position. The signature is the resulting syndrome when there is a single bit error exactly in that position. Each DQ #K transmits sixteen bits, as one bit per each burst beat, with eight consecutive bits composing a symbol. This results in two consecutive symbols for each DQ #K. Rows five to eight of the first eight columns of H^{T} 601 following the identity matrix associated with the DLEP data provides symbol #1 for DQ #1 for die #1. Rows five to eight of the second eight columns of H^{T} 601 following the identity matrix associated with the DLEP data provides symbol #2 for DQ #1 for die #1. Symbol #1 and symbol #2 for each DQ #K, K=2 . . . 8, have the values as symbol #1 and symbol #2 for each DQ #1. The columns differ in the rows one to four of the columns identifying the die number and the DQ number. Rows five to eight of the second eight columns of H^{T} 601 following the identity matrix associated with the DLEP data are associated with an amount of data associated with each data bus of each memory die of the subset of memory dies.

H^{T} 601 for BSEC can be implemented such that a payload error in a die of the two bounded dies will not corrupt data of the other die in the grouping of the two dies. In addition, a DQ error will not corrupt any other DQ. The columns of H^{T} 601 are different from each other except for column 616 of FIG. 6A, which is the second column of the identity matrix of the DLEP data section of H^{T} 601, and column 617 of FIG. 6A, which is the first column of the ordinary data section of H^{T} 601. Column 616 and column 617 are an exception to the uniqueness of the columns of H^{T} 601. This exception can be managed. In column 617, if an error occurs in bit #1 of symbol #1 of die #1, a correction is not applied, recognizing the syndrome pattern 01000000 disables the correction. In column 616, if an error occurs in bit #2 of DLEP data of die #2, a correction is not applied, recognizing the syndrome pattern 01000000 disables the correction. If two errors occur, one error in bit #2 of DLEP data of die #2 (column 616) and one error in bit #1 of symbol #1 of die #1 (column 617) no correction is applied because the syndrome results to be 0. This approach for decoding follows from the following. The result of adding an odd number of vectors in a die is a vector in the same die. The result of adding an even number of vectors in a die is a vector not belonging to the parity check matrix. The result of adding an odd number of vectors in a DQ is a vector in the same DQ. The result of adding an even number of vectors in a DQ is a vector not belonging to the priority check matrix.

The BSEC logic circuitry is a special Hamming decoder, where the BSEC logic circuitry include a single error correcting code with the “bounded” property that if an uncorrectable error falls inside a single DQ then the error operated on by the BSEC is contained in the same DQ and does not corrupt other DQs. The probability for a standard Hamming decoder to be unable to correct an error is

$${P}_{e}^{std} = 1 - {( 1 - p )}^{136} - 136 {p ( 1 - p )}^{1 \; 36 - 1} ,$$

where p is the probability of an error represented by a bit error rate (BER). The probability for the BSEC Hamming decoder to be unable to correct an error is

$${P}_{e}^{B S E C} = 1 - {( 1 - p )}^{136} - 134 {p ( 1 - p )}^{136 - 1} .$$

The discrepancy between

$${P}_{e}^{std} and {P}_{e}^{B S E C}$$

increases at lower DER. Errors can be categorized as hard errors, soft intermittent errors, or soft temporary error. Hard errors are errors that once occurred are “stable” along the life of the device. Such errors are due to failures such as defects, breakages, breakdowns, or other similar physical occurrences. Soft intermittent errors are errors that are fixed in position but that do not always occur. The bit position is “stable” since the error is only present sometimes. Soft temporary errors are errors that are completely random, in space and time. Typically, a significant portion (for example more than 50%) of single bit errors are hard or intermittent soft. These two single bit error categories have a fixed geometric position, once the error occurred for the first time. The probability of an error, p, can be given by

$$p = {p}_{rnd} + {p}_{fix} - {p}_{rnd} {p}_{fix} \approx {p}_{rnd} + {p}_{fix}$$

for small residual bit error rate (RBER). The term, p_{rnd}, is the probability of having a random error in the array, where random means in position and in time. The term, p_{fix}, is the probability of having an error in which the position is fixed in the array but the time when it occurs can be either random (intermittent errors) or fixed, i.e., always active (hard errors).

The discrepancy between

$${P}_{e}^{std} and {P}_{e}^{B S E C}$$

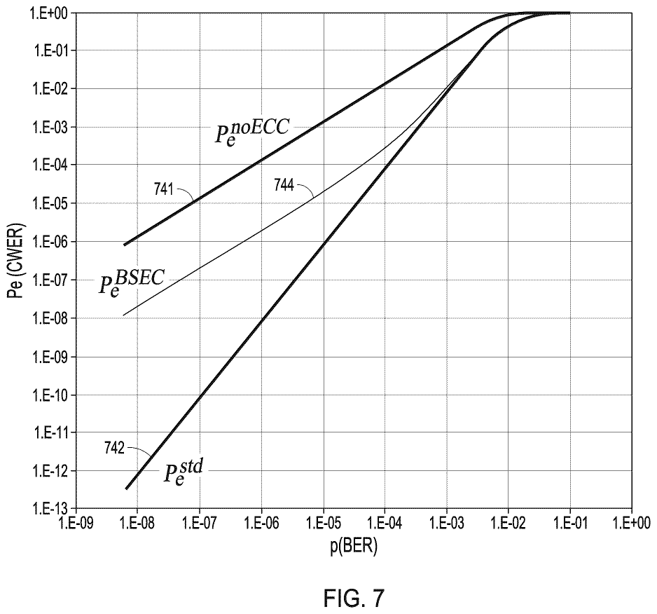

increases at lower BER as shown in FIG. 7, which represents plots of probability of codeword error (CWER) versus probability of error in units of bit error rate (BER). The discrepancy can, at least partially, be due to two positions in a transposed parity check matrix having the same syndrome such as shown as column 616 an column 617 of FIG. 6A. FIG. 7 shows the differences between the probability of not being able to correct an error of a codeword for a standard Hamming decoder, curve 742, and for a BSEC Hamming decoder, curve 744, with respect to the probability when no error code correction (ECC), curve 741, is used. The codeword error probability of the BSEC case can be reduced by reconfiguring the assignment of the error position in the H column. If the BSEC decoder produces the syndrome [01000000]^{T}, the assignment can be changed, starting from the next access in a write, by exchanging, for example, column [01000000]^{T} (column 617 of H^{T} 601 of FIG. 6A, which is bit-vector 0 (b₀) of the symbol) with column [01000111]^{T} (column 619 of H^{T} 601 of FIG. 6A, which is bit-vector 7 (b₇) of the same symbol of the same DQ, for example (symbol #1, DQ #1) for H^{T} 601 of FIG. 6A. This exchange is performed for a specific device physical address (DPA). A register can be used to store this DPA to indicate when to provide the reconfigured assignment. The reconfiguration can be performed in syndrome computation. Once the original syndrome S is obtained, the new syndrome can be computed as:

$${S}^{n e w} = S + ( {b}_{0} + {b}_{7} ) [ \begin{matrix}0 \\ 1 \\ 0 \\ 0 \\ 0 \\ 0 \\ 0 \\ 0\end{matrix} ] + ( {b}_{7} + {b}_{0} ) [ \begin{matrix}0 \\ 1 \\ 0 \\ 0 \\ 0 \\ 1 \\ 1 \\ 1\end{matrix} ] = S + ( {b}_{0} + {b}_{7} ) [ \begin{matrix}0 \\ 0 \\ 0 \\ 0 \\ 0 \\ 1 \\ 1 \\ 1\end{matrix} ] ,$$

which can be written as:

$${S}_{i}^{n e w} = {S}_{i} , i = 0 , … , 4$$

$${S}_{5}^{n e w} = {S}_{5} + ( {b}_{0} + {b}_{7} )$$

$${S}_{6}^{n e w} = {S}_{6} + ( {b}_{0} + {b}_{7} )$$

$${S}_{7}^{n e w} = {S}_{7} + ( {b}_{0} + {b}_{7} )$$

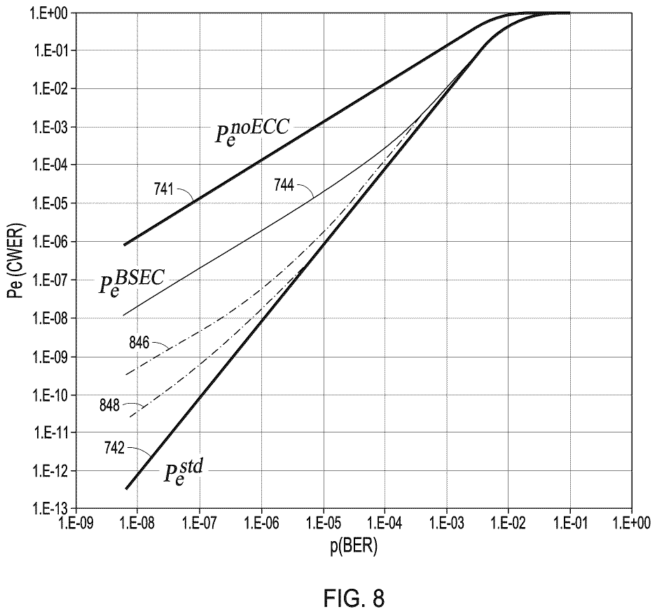

FIG. 8 shows possible reductions of the discrepancy between curve 744 and curve 742. Curve 846 shows a reduction based on single bit partitioning in hard, soft intermittent, and soft temporary errors. Curve 848 shows a reduction based on implementation of the above reassignment technique after error in the critical positions of common syndromes.

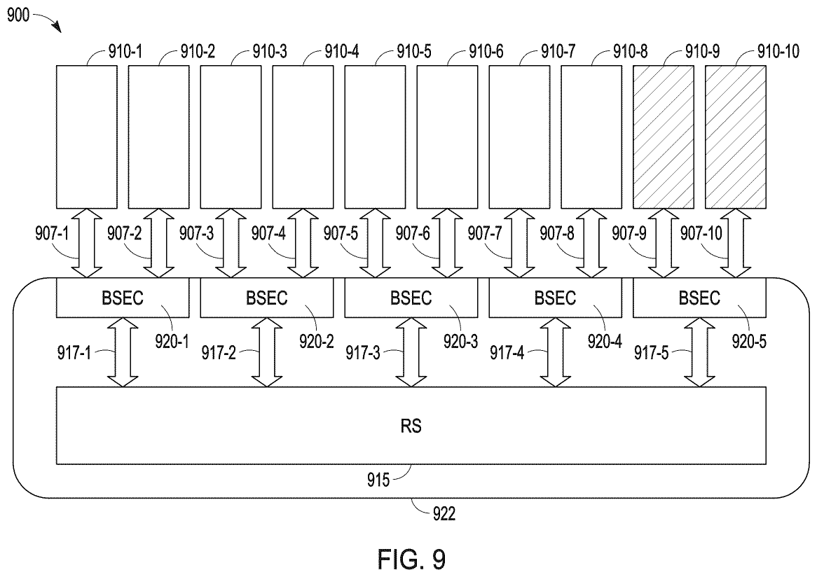

FIG. 9 is a representation of at least portions of a memory system 900 having a media subsystem with at least one rank of memory dies, where BSEC operations can be implemented for the data of the media subsystem. The at least one rank of memory dies can have ten memory dies 910-1; 910-2 . . . 910-10, where the at least one rank is coupled to a correction controller 922 by a bus. Memory dies 910-1; 910-2 . . . 910-8 can be configured to hold ordinary data. Memory dies 910-9 and 910-10 can be configured to hold RS parity data. The bus can include individual buses 907-1, 907-2 . . . 907-10 between each of memory dies 910-1; 910-2 . . . 910-10 and correction controller 922. Individual bus 907-K, K=1, 2 . . . 10, can include four DQ lines and one DMI coupled to memory die 910-K; K=1, 2 . . . 10, respectively, of the at least one rank of memory dies.

Correction controller 922 can have five BSEC correction logic circuits, labeled as BSEC 920-1, 920-2, 920-3, 920-4, and 920-5 in FIG. 9, coupled to the at least one rank of memory dies by the bus. BSEC 920-1 can be coupled to memory die 910-1 by individual bus 907-1 and to memory die 910-2 by individual bus 907-2. BSEC 920-2 can be coupled to memory die 910-3 by individual bus 907-3 and to memory die 910-4 by individual bus 907-4. BSEC 920-3 can be coupled to memory die 910-5 by individual bus 907-5 and to memory die 910-6 by individual bus 907-6. BSEC 920-4 can be coupled to memory die 910-7 by individual bus 907-7 and to memory die 910-8 by individual bus 907-8. BSEC 920-5 can be coupled to memory die 910-9 by individual bus 907-9 and to memory die 910-10 by individual bus 907-10. A BSEC logic circuit of the five BSEC logic circuits assigned to operate on data of the data frame retrieved from two memory dies of the ten memory dies in a manner as taught herein, where each single error correction logic circuit is structured to generate a codeword of the data from the respective two memory dies bounded such that multiple errors of a first region of the two dies does not affect a second region of the two dies.

Correction controller 922 can also include a RS decoder, labeled as RS 915, to operate on results of operation of BSEC 920-1, 920-2, 920-3, 920-4, and 920-5. Once data arrives to correction controller 922, which can be an ASIC controller, the data can be processed in two steps. The first step includes processing the data using BSECs 920-1, 920-2, 920-3, 920-4, and 920-5. The second step includes processing by RS 915, which can process non-DLEP bits that may have been corrected by BSECs 920-1, 920-2, 920-3, 920-4, and 920-5 as taught herein. With each BSEC processing a code word of one hundred twenty-eight data bits and eight non-DLEP bits, RS 915 can process six hundred forty non-DLEP bits possibly corrected by the BSECs. Optionally, RS 915 can be implemented using multiple RS decoders such as, but not limited to, two or four RS decoders. Different realization of RS circuitry can be implemented in RS 915. Memory dies 910-9 and 910-10 provide the parity bits of the Reed-Solomon code. BSEC 920-5 is a specific BSEC decoder to correct single bit error of the data accessed on memory dies 910-9 and 910-10 that can be implemented to operate in the same manner as for every other pair of memory dies 910-1 . . . 910-8. After the possible corrections operated by the BSECs 920-1 . . . 920-5 individually, a RS codeword is formed by RS 915 using the corrected payload bits of all the five BSECs. RS 915 can include encoders in the write path to memory dies 910-1 . . . 910-10 and decoders in the read path to these memory dies. Each of BSECs 920-1 . . . 920-5 can have an an encoder used in write mode and a decoder used in read mode. RS 915 can have a RS encoder used in write mode and a RS decoder used in read mode.

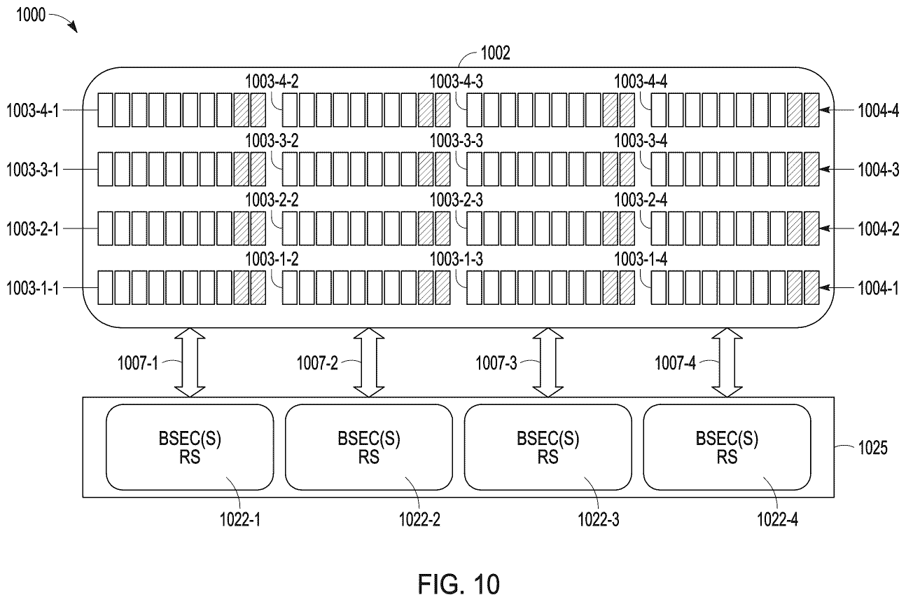

FIG. 10 is a representation of an embodiment of an memory system 1000 having a media subsystem 1002 coupled to a controller by multiple buses 1007-1, 1007-2, 1007-3, and 1007-4, where bounded single error correction operations can be implemented for the data of media subsystem 1002. Media subsystem 1002 includes groups 1004-1, 1004-2, 1004-3, and 1004-4 of memory dies. Group 1004-1 includes four first ranks 1003-1-1, 1003-1-2, 1003-1-3, and 1003-1-4 of memory dies. Group 1004-2 includes four second ranks 1003-2-1, 1003-2-2, 1003-2-3, and 1003-2-4 of memory dies. Group 1004-3 includes four first ranks 1003-3-1, 1003-3-2, 1003-3-3, and 1003-3-4 of memory dies. Group 1004-4 includes four first ranks 1003-4-1, 1003-4-2, 1003-4-3, and 1003-4-4 of memory dies. Each rank of these sixteen ranks can be configured as ten memory dies arranged as eight memory dies of data and two memory dies of RS data as configured in memory system 900 of FIG. 9.

The four ranks 1003-1-1, 1003-2-1, 1003-3-1, and 1003-4-1 can be coupled to bus 1007-1 to transfer data bits from each rank of the four ranks via a forty bit channel and to transfer DLEP bits via ten DMI lines. Bus 1007-1 is coupled to a correction controller 1022-1 of controller 1025, where correction controller 1022-1 can include five BSECs coupled to a RS. The arrangement of each rank of ranks 1003-1-1, 1003-2-1, 1003-3-1, and 1003-4-1 can be coupled to and operate with respect to the five BSECs and RS of correction controller 1022-1 in a manner similar to the arrangement of FIG. 9.

The four ranks 1003-1-2, 1003-2-2, 1003-3-2, and 1003-4-2 can be coupled to bus 1007-2 to transfer data bits from each rank of the four ranks via a forty bit channel and to transfer DLEP bits via ten DMI lines. Bus 1007-2 can be coupled to a correction controller 1022-2 of controller 1025, where correction controller 1022-2 can include five BSECs coupled to a RS. The arrangement of each rank of ranks 1003-1-2, 1003-2-2, 1003-3-2, and 1003-4-2 can be coupled to and operate with respect to the five BSECs and RS of correction controller 1022-2 in a manner similar to the arrangement of FIG. 9.

The four ranks 1003-1-3, 1003-2-3, 1003-3-3, and 1003-4-3 can be coupled to bus 1007-3 to transfer data bits from each rank of the four ranks via a forty bit channel and to transfer DLEP bits via ten DMI lines. Bus 1007-3 can be coupled to a correction controller 1022-3 of controller 1025, where correction controller 1022-3 can include five BSECs coupled to a RS. The arrangement of each rank of ranks 1003-1-3, 1003-2-3, 1003-3-3, and 1003-4-3 can be coupled to and operate with respect to the five BSECs and RS of correction controller 1022-3 in a manner similar to the arrangement of FIG. 9.

The four ranks 1003-1-4, 1003-2-4, 1003-3-4, and 1003-4-4 can be coupled to bus 1007-4 to transfer data bits from each rank of the four ranks via a forty bit channel and to transfer DLEP bits via ten DMI lines. Bus 1007-4 can be coupled to a correction controller 1022-4 of controller 1025, where correction controller 1022-4 can include five BSECs coupled to a RS. The arrangement of each rank of ranks 1003-1-4, 1003-2-4, 1003-3-4, and 1003-4-4 can be coupled to and operate with respect to the five BSECs and RS of correction controller 1022-4 in a manner similar to the arrangement of FIG. 9.

Memory system 1000 can be implemented with low power fifth-generation double data rate (DDR5) SDRAM devices, which can be referred to as LP5s, with a DQ bus of four bits. Each of these LP5s can be implemented with DLEP on to transfer DLEP data along with storage data that is transferred on a forty bit channel between the LP5s and BSEC logic circuits, where the BSEC logic circuits external to the LP5s. The BSEC logic circuits can include circuit to operate codes to provide the single error correction in a bounded manner. Other memory device types can be structured in a similar manner.

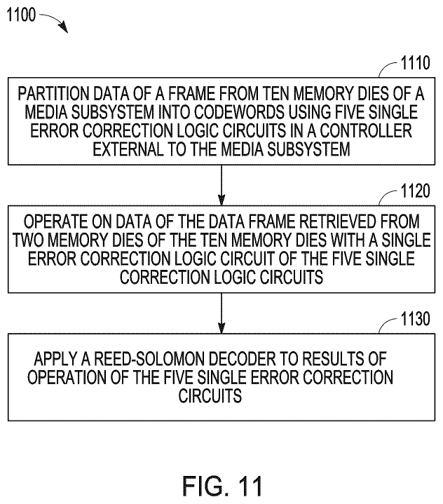

FIG. 11 is a flow diagram of features of an embodiment of an example method 1100 of operating a memory system. Method 1100 can be performed by memory system 900 of FIG. 9 or memory system 1000 of FIG. 10. At 1110, data of a data frame from ten memory dies of a media subsystem is partitioned into five codewords using five SEC logic circuits in a controller external to the media subsystem and coupled to the media subsystem. A SEC logic circuit of the five SEC logic circuits operates on data of the data frame retrieved from two memory dies of the ten memory dies. Each SEC logic circuit of the five SEC logic circuits can be structured to operate as a BSEC logic circuit with respect to the two memory dies coupled to the respective SEC logic circuit.

At 1120, a Reed-Solomon decoder is applied to operate on results of operation of the five SEC logic circuits. The results of operation of the five SEC logic circuits can include single bit corrections by one or more of the five SEC logic circuits. The results of operation of the five SEC logic circuits can include no bit corrections by one or more of the five SEC logic circuits when no error occurs in the data processed.

Variations of method 1100 or methods similar to method 1100 can include a number of different embodiments that may be combined depending on the application of such methods or the architecture or operation flow for which such methods are implemented. Such methods can include each single error correction logic circuit of the five single error correction logic circuits using a parity check matrix transposed for a syndrome pattern assignment for the data of two memory dies. The parity check matrix transposed can have eight rows and one hundred thirty-six columns with the first eight columns and eight rows being an identity matrix associated with parity data of the two memory dies and the reminder of the eight rows and one hundred thirty-six columns applied to array data. The first two rows of the parity check matrix transposed, after the identity matrix, can correspond to the two memory dies, effectively identifying the two memory dies. The third and fourth rows of the parity check matrix transposed, after the identity matrix, can correspond to data query lines of each of the two memory dies, effectively; identifying the data query lines of each of the two memory dies. The fifth through eighth rows of the parity check matrix transposed, after the identity matrix, can correspond to sixteen bits transferred for each data query line of each of the two memory dies. This matrix can provide for bounded operation of the SEC logic circuits such that multiple errors in one of the two memory dies does not lead to multiple errors in the second of the two memory dies.

Variations of method 1100 or methods similar to method 1100 can include not applying a correction if an error occurs in a bit number one of a symbol number one corresponding to a die number one, recognizing syndrome pattern 01000000 as disabling the correction. Variations can include not applying a correction if an error occurs in a bit number two of parity data of a die number two, recognizing syndrome pattern 01000000 as disabling the correction. Variations can include applying no correction if errors occur in a bit number two of parity data of a die number two and in a bit number one of a symbol number one of die number one.

Electronic devices can be broken down into several main components: a processor (e.g., a central processing unit (CPU) or other main processor); memory (e.g., one or more volatile or non-volatile RAM memory device, such as DRAM, mobile or low-power double-data-rate synchronous DRAM (DDR SDRAM), etc.); and a storage device (e.g., non-volatile memory (NVM) device, such as flash memory, ROM, a solid-state drive (SSD), a MultiMediaCard (MMC), or other memory card structure or assembly, etc.). Electronic devices, such as mobile electronic devices (e.g., smart phones, tablets, etc.), electronic devices for use in automotive applications (e.g., automotive sensors, control units, driver-assistance systems, passenger safety or comfort systems, etc.), and internet-connected appliances or devices (e.g., Internet-of-Things (IoT) devices, etc.), have varying storage needs depending on, among other things, the type of electronic device, use environment, performance expectations, etc. In certain examples, electronic devices can include a user interface (e.g., a display, touch-screen, keyboard, one or more buttons, etc.), a graphics processing unit (GPU), a power management circuit, a baseband processor or one or more transceiver circuits, etc. As used herein, “processor device” means any type of computational circuit such as, but not limited to, a microprocessor, a microcontroller, a graphics processor, a digital signal processor (DSP), or any other type of processor or processing circuit, including a group of processors or multi-core devices.

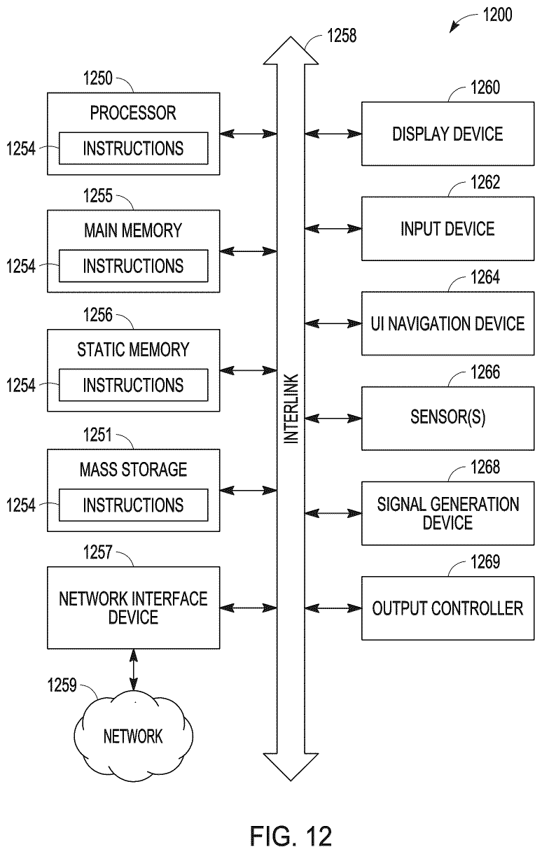

FIG. 12 illustrates a block diagram of an example machine 1200 that can include one or more memory systems coupled to a controller by multiple buses, where bounded single error correction operations can be implemented in the controller for the data of the one or more memory systems. In alternative embodiments, machine 1200 may operate as a standalone device or may be connected (e.g., networked) to other machines. In a networked deployment, machine 1200 may operate in the capacity of a server machine, a client machine, or both in server-client network environments. In an example, machine 1200 may act as a peer machine in peer-to-peer (P2P) (or other distributed) network environment. Machine 1200 may be a personal computer (PC), a tablet PC, a set-top box (STB), a personal digital assistant (PDA), a mobile telephone, a web appliance, an IoT device, automotive system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform one or more of methodologies such as, but not limited to, cloud computing, software as a service (SaaS), or other computer cluster configurations. Example machine 1200 can include one or more apparatus having structures with components as discussed with respect to memory system 900 of FIG. 9 or memory system 1000 of FIG. 10.

Machine (e.g., computer system) 1200 may include a hardware processor 1250 (e.g., a CPU, a GPU, a hardware processor core, or any combination thereof), a main memory 1255 and a static memory 1256, some or all of which may communicate with each other via an interlink (e.g., bus) 1258. Machine 1200 may further include a display device 1260, an alphanumeric input device 1262 (e.g., a keyboard), and a user interface (UI) navigation device 1264 (e.g., a mouse). In an example, display device 1260, alphanumeric input device 1262, and UI navigation device 1264 may be a touch screen display. Machine 1200 may additionally include a mass storage (e.g., drive unit) 1251, a signal generation device 1268 (e.g., a speaker), a network interface device 1257, and one or more sensors 1266, such as a global positioning system (GPS) sensor, compass, accelerometer, or other sensor. Machine 1200 may include an output controller 1269, such as a serial (e.g., USB, parallel, or other wired or wireless (e.g., infrared (IR), near field communication (NFC), etc.) connection to communicate or control one or more peripheral devices (e.g., a printer, card reader, etc.).

Machine 1200 may include a machine-readable medium on which is stored one or more sets of data structures or instructions 1254 (for example, software or microcode) embodying or utilized by machine 1200. Instructions 1254 may also reside, completely or at least partially, within main memory 1255, within static memory 1256, within mass storage 1251, or within hardware processor 1250 during execution thereof by machine 1200. In an example, one or any combination of hardware processor 1250, main memory 1255, static memory 1256, or mass storage 1251 may constitute machine-readable medium. Machine-readable medium can be a single medium or multiple media (e.g., a centralized or distributed database, or associated caches and servers) configured to store one or more instructions 1254.

The term “machine-readable medium” may include any medium that is capable of storing instructions for execution by machine 1200 and that cause machine 1200 to perform any one or more of the techniques for which machine 1200 is implemented. Non-limiting machine-readable medium examples may include solid-state memories, and optical and magnetic media. Non-volatile machine-readable medium may include semiconductor memory devices such as EPROM, EEPROM, and flash memory devices; magnetic disks, such as internal hard disks and removable disks; magneto-optical disks; and compact disc-ROM (CD-ROM) and digital versatile disc-read only memory (DVD-ROM) disks. Volatile machine-readable medium may include (RAM), DRAM, SRAM, SDRAM, or LP5.

Instructions 1254 (e.g., software, programs, microcode, an operating system (OS), etc.) or other data stored on mass storage 1251, can be accessed by main memory 1255 for use by processor 1250. Main memory 1255 (e.g., DRAM) is typically fast, but volatile, and thus a different type of storage than mass storage 1251 (e.g., an SSD), which is suitable for long-term storage, including while in an “off”′ condition. Instructions 1254 or data in use by a user or machine 1200 are typically loaded in main memory 1255 for use by processor 1250. When main memory 1255 is full, virtual space from mass storage 1251 can be allocated to supplement main memory 1255; however, because mass storage 1251 is typically slower than main memory 1255, and write speeds are typically at least twice as slow as read speeds, use of virtual memory can greatly reduce user experience due to storage device latency (in contrast to main memory 1255, e.g., DRAM). Further, use of mass storage 1251 for virtual memory can greatly reduce the usable lifespan of mass storage 1251.

Storage devices optimized for mobile electronic devices, or mobile storage, traditionally include MMC solid-state storage devices (e.g., micro Secure Digital (microSD™) cards, etc.). MMC devices include a number of parallel interfaces (e.g., an 8-bit parallel interface) with a host device and are often removable and separate components from the host device. In contrast, eMMC™ devices are attached to a circuit board and considered a component of the host device, with read speeds that rival SATA based SSD devices. However, demand for mobile device performance continues to increase, such as to fully enable virtual or augmented-reality devices, utilize increasing networks speeds, etc. In response to this demand, storage devices have shifted from parallel to serial communication interfaces. UFS devices, including controllers and firmware, communicate with a host device using a low-voltage differential signaling (LVDS) serial interface with dedicated read/write paths, further advancing greater read/write speeds.

Instructions 1254 may further be transmitted or received over a network 1259 using a transmission medium via network interface device 1257 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.10.4 family of standards, peer-to-peer (P2P) networks, among others. In an example, network interface device 1257 may include one or more physical jacks (e.g., Ethernet, coaxial, or phone jacks) or one or more antennas to connect to the communications network 1259. In an example, network interface device 1257 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any tangible medium that is capable of transporting instructions for execution by machine 1200 or data to or from machine 1200. The transportation can include using digital or analog communications signals that can be transmitted over the transmission medium to facilitate communication of such software or data.

The following are example embodiments of systems and methods, in accordance with the teachings herein.

An example memory system 1 can comprise a media subsystem and a controller external to the media subsystem and coupled to the media subsystem. The media subsystem can have multiple memory dies for data storage and dies for parity. The controller can have multiple single error correction logic circuits to operate on a data frame received from a set of memory dies of the multiple memory dies, where each single error correction logic circuit is assigned to operate on data of the data frame retrieved from a subset of the set of memory dies. The subset can include at least two memory dies. The controller can have a decoder to operate on results of operation of the single error correction circuits.

An example memory system 2 can include features of example memory system 1 and can include each single error correction logic circuit structured to generate a codeword of the data from the respective subset bounded such that multiple errors of a first region of the respective subset do not affect a second region of the respective subset.

An example memory system 3 can include features of example memory system 2 and any of the preceding example memory systems and can include the first region being one memory die of the subset of memory dies and the second region being a different memory die of the subset of memory dies.

An example memory system 4 can include features of example memory system 2 and any of the preceding example memory systems and can include each single error correction logic circuit arranged to provide parity bits for the codeword of the data from the respective subset bounded.

An example memory system 5 can include features of example memory system 2 and any of the preceding example memory systems and can include each single error correction logic circuit being structured to use a parity check matrix for a syndrome pattern assignment corresponding to the respective subset.

An example memory system 6 can include features of example memory system 5 and any of the preceding example memory systems and can include the parity check matrix transposed to include rows associated with each memory die of the subset of memory dies, rows associated with data query lines from which data is retrieved with respect to each memory die of the subset of memory dies, and rows associated with amount of data associated with each data query line of each memory die of the subset of memory dies.

An example memory system 7 can include features of any of the preceding example memory systems and can include the set of memory dies having eight data memory dies and two parity memory dies and each subset having two memory dies, with each of the eight memory dies and the two parity memory dies coupled to the controller by four data query lines and each of the memory dies handling sixteen bits transferred per data query line.

In an example memory system 8, any of the memory systems of example memory systems 1 to 7 may be incorporated into an electronic apparatus further comprising a host processor or memory controller and a communication bus extending between the host processor/memory controller and the memory device.

In an example memory system 9, any of the memory systems of example memory systems 1 to 8 may be modified to include any structure presented in another of example memory system 1 to 8.

In an example memory system 10, any apparatus associated with the memory systems of example memory systems 1 to 9 may further include a machine-readable storage device configured to store instructions as a physical state, wherein the instructions may be used to perform one or more operations of the apparatus.

In an example memory system 11, any of the memory systems of example memory systems 1 to 10 may be formed or operated in accordance with any of the below example methods 1 to 9.

An example memory system 12 can comprise a media subsystem, a bus, and a correction controller. The media subsystem can have at least one rank of memory dies, where each rank has ten memory dies. The bus can have four data query lines and one direct media interface to each of the ten memory dies of the at least one rank of memory dies. The correction controller can be coupled to the at least one rank of memory dies by the bus. The correction controller can have five single error correction logic circuits to operate on a data frame received from the ten memory dies of a rank of the at least one rank of memory dies. A single error correction logic circuit of the five single error correction logic circuits can be assigned to operate on data of the data frame retrieved from two memory dies of the ten memory dies of the rank. The correction controller can have a Reed-Solomon decoder to operate on results of operation of the five single error correction logic circuits.

An example memory system 13 can include features of example memory system 12 and can include each single error correction logic circuit being structured to generate a codeword of the data from the respective two memory dies bounded such that multiple errors of a first region of the two dies does not affect a second region of the two dies.

An example memory system 14 can include features of example memory system 13 and example memory system 12 and can include the first region being one memory die of the two memory dies and the second region being a second memory die of the two memory dies.

An example memory system 15 can include features of example memory system 13 and any of the preceding example memory systems 12 or 14 and can include the codeword having one hundred twenty-eight bits and eight parity bits.

An example memory system 16 can include features of any of the preceding example memory systems 12 to 15 and can include each single error correction logic circuit being structured to use a parity check matrix for a syndrome pattern assignment for the data of the two memory dies.

An example memory system 17 can include features of any of the preceding example memory systems 12 to 16 and can include the parity check matrix transposed having: eight rows and one hundred thirty-six columns with first eight columns and eight rows being an identity matrix associated with parity data of the two memory dies and remainder of the eight rows and one hundred thirty-six columns corresponding to array data; first two rows after the identity matrix corresponding to the two memory dies; third and fourth rows after the identity matrix corresponding to data query lines to each of the two memory dies; and fifth through eighth rows after the identity matrix associated with sixteen bits transferred for each data query line of each of the two memory dies.

An example memory system 18 can include features of any of the preceding example memory systems 12 to 17 and can include the media subsystem to include four groups of four ranks, with the at the least one rank of memory dies being one rank of a collection of four ranks of memory dies distributed in the four groups.

An example memory system 19 can include features of example memory system 18 and any of the preceding example memory systems 12 to 17 and can include the collection of four ranks of memory dies distributed in the four groups being coupled to the five single error correction logic circuits.

In an example memory system 20, any of the memory systems of example memory systems 12 to 19 may be incorporated into an electronic apparatus further comprising a host processor or memory controller and a communication bus extending between the host processor/memory controller and the memory device.

In an example memory system 21, any of the memory systems of example memory systems 12 to 20 may be modified to include any structure presented in another of example memory system 12 to 20.

In an example memory system 22, any apparatus associated with the memory systems of example memory systems 12 to 20 may further include a machine-readable storage device configured to store instructions as a physical state, wherein the instructions may be used to perform one or more operations of the apparatus.

In an example memory system 23, any of the memory systems of example memory systems 12 to 22 may be formed or operated in accordance with any of the below example methods 1 to 9.

An example method 1 of operating a memory system can comprise partitioning data of a data frame from ten memory dies of a media subsystem into five codewords using five single error correction logic circuits in a controller external to the media subsystem and coupled to the media subsystem, with a single error correction logic circuit of the five single error correction logic circuits operating on data of the data frame retrieved from two memory dies of the ten memory dies; and applying a Reed-Solomon decoder to operate on results of operation of the five single error correction logic circuits.

An example method 2 of operating a memory system can include features of example method 1 of operating a memory system and can include each single error correction logic circuit of the five single error correction logic circuits using a parity check matrix transposed for a syndrome pattern assignment for the data of two memory dies, the parity check matrix transposed having: eight rows and one hundred thirty-six columns with first eight columns and eight rows being an identity matrix associated with parity data of the two memory dies and reminder of the eight rows and one hundred thirty-six columns applied to array data; first two rows of the parity check matrix transposed, after the identity matrix, identifying the two memory dies; third and fourth rows of the parity check matrix transposed, after the identity matrix, identifying data query lines of each of the two memory dies; and fifth through eighth rows of the parity check matrix transposed, after the identity matrix, corresponding to sixteen bits transferred for each data query line of each of the two memory dies.

An example method 3 of operating a memory system can include features of any of the preceding example methods of operating a memory system and can include not applying a correction if an error occurs in a bit number one of a symbol number one corresponding to a die number one, recognizing syndrome pattern 01000000 as disabling the correction.

An example method 4 of operating a memory system can include features of any of the preceding example methods of operating a memory system and can include not applying a correction if an error occurs in a bit number two of parity data of a die number two, recognizing syndrome pattern 01000000 as disabling the correction.

An example method 5 of operating a memory system can include features of any of the preceding example methods of operating a memory system and can include applying no correction if errors occur in a bit number two of parity data of a die number two and in a bit number one of a symbol number one of die number one.

In an example method 6, any of the example methods 1 to 5 of operating a memory system may be performed in operating a memory system further comprising a host processor and a communication bus extending between the host processor and a memory system.

In an example method 7 of operating a memory system, any of the example methods 1 to 6 of operating a memory system may be modified to include operations set forth in any other of example methods 1 to 6.

In an example method 8 of operating a memory system, any of the example methods 1 to 7 of operating a memory system may be implemented at least in part through use of instructions stored as a physical state in one or more machine-readable storage devices.

An example method 9 of operating a memory system can include features of any of the preceding example methods 1 to 8 of operating a memory system and can include performing functions associated with any features of example memory devices 1 to 11 or memory devices electronic devices 12 to 22.

An example machine-readable storage device storing instructions, that when executed by one or more processors, cause a machine to perform operations, can comprise instructions to perform functions associated with any features of example memory systems 1 to 11, example memory systems 12 to 22 or perform methods associated with any features of example methods 1 to 9 of operating a memory system.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description.

What is claimed is:

1. A memory system comprising:
a media subsystem having multiple memory dies for data storage and dies for parity; and
a controller external to the media subsystem and coupled to the media subsystem, the controller having:
multiple single error correction logic circuits to operate on a data frame received from a set of memory dies of the multiple memory dies, each single error correction logic circuit assigned to operate on data of the data frame retrieved from a subset of the set of memory dies, the subset including at least two memory dies;
and
a decoder to operate on results of operation of the multiple single error correction circuits.

2. The memory system of claim 1, wherein each single error correction logic circuit is structured to generate a codeword of the data from the respective subset bounded such that multiple errors of a first region of the respective subset do not affect a second region of the respective subset.

3. The memory system of claim 2, wherein the first region is one memory die of the subset of memory dies and the second region is a different memory die of the subset of memory dies.

4. The memory system of claim 2, wherein each single error correction logic circuit is arranged to provide parity bits for the codeword of the data from the respective subset bounded.

5. The memory system of claim 2, wherein each single error correction logic circuit is structured to use a parity check matrix for a syndrome pattern assignment corresponding to the respective subset.

6. The memory system of claim 5, wherein the parity check matrix transposed includes rows associated with each memory die of the subset of memory dies, rows associated with data query lines from which data is retrieved with respect to each memory die of the subset of memory dies, and rows associated with amount of data associated with each data query line of each memory die of the subset of memory dies.

7. The memory system of claim 1, wherein the set of memory dies has eight data memory dies and two parity memory dies and each subset has two memory dies, with each of the eight memory dies and the two parity memory dies coupled to the controller by four data query lines and each of the memory dies handles sixteen bits transferred per data query line.

8. A memory system comprising:
a media subsystem having at least one rank of memory dies, each rank having ten memory dies;
a bus having four data query lines and one direct media interface to each of the ten memory dies of the at least one rank of memory dies;
a correction controller coupled to the at least one rank of memory dies by the bus, the correction controller having:
five single error correction logic circuits to operate on a data frame received from the ten memory dies of a rank of the at least one rank of memory dies, a single error correction logic circuit of the five single error correction logic circuits assigned to operate on data of the data frame retrieved from two memory dies of the ten memory dies of the rank; and
a Reed-Solomon decoder to operate on results of operation of the five single error correction logic circuits.

9. The memory system of claim 8, wherein each single error correction logic circuit is structured to generate a codeword of the data from the respective two memory dies bounded such that multiple errors of a first region of the two dies does not affect a second region of the two dies.

10. The memory system of claim 9, wherein the first region is one memory die of the two memory dies and the second region is a second memory die of the two memory dies.

11. The memory system of claim 9, wherein the codeword has one hundred twenty-eight bits and eight parity bits.

12. The memory system of claim 8, wherein each single error correction logic circuit is structured to use a parity check matrix for a syndrome pattern assignment for the data of the two memory dies.

13. The memory system of claim 12, wherein the parity check matrix transposed has:
eight rows and one hundred thirty-six columns with first eight columns and eight rows being an identity matrix associated with parity data of the two memory dies and remainder of the eight rows and one hundred thirty-six columns corresponding to array data;
first two rows after the identity matrix corresponding to the two memory dies;
third and fourth rows after the identity matrix corresponding to data query lines to each of the two memory dies; and
fifth through eighth rows after the identity matrix associated with sixteen bits transferred for each data query line of each of the two memory dies.

14. The memory system of claim 8, wherein the media subsystem includes four groups of four ranks, with the at the least one rank of memory dies being one rank of a collection of four ranks of memory dies distributed in the four groups.

15. The memory system of claim 14, wherein the collection of four ranks of memory dies distributed in the four groups are coupled to the five single error correction logic circuits.

16. A method of operating a memory system, the method comprising:
partitioning data of a data frame from ten memory dies of a media subsystem into five codewords using five single error correction logic circuits in a controller external to the media subsystem and coupled to the media subsystem, with a single error correction logic circuit of the five single error correction logic circuits operating on data of the data frame retrieved from two memory dies of the ten memory dies; and
applying a Reed-Solomon decoder to operate on results of operation of the five single error correction logic circuits.

17. The method of claim 16, wherein the method includes each single error correction logic circuit of the five single error correction logic circuits using a parity check matrix transposed for a syndrome pattern assignment for the data of two memory dies, the parity check matrix transposed having:
eight rows and one hundred thirty-six columns with first eight columns and eight rows being an identity matrix associated with parity data of the two memory dies and reminder of the eight rows and one hundred thirty-six columns applied to array data;
first two rows of the parity check matrix transposed, after the identity matrix, identifying the two memory dies;
third and fourth rows of the parity check matrix transposed, after the identity matrix, identifying data query lines of each of the two memory dies; and
fifth through eighth rows of the parity check matrix transposed, after the identity matrix, corresponding to sixteen bits transferred for each data query line of each of the two memory dies.

18. The method of claim 17, wherein the method includes not applying a correction if an error occurs in a bit number one of a symbol number one corresponding to a die number one, recognizing syndrome pattern 01000000 as disabling the correction.

19. The method of claim 17, wherein the method includes not applying a correction if an error occurs in a bit number two of parity data of a die number two, recognizing syndrome pattern 01000000 as disabling the correction.

20. The method of claim 17, wherein the method includes applying no correction if errors occur in a bit number two of parity data of a die number two and in a bit number one of a symbol number one of die number one.
